(19) United States
(12) Patent Application Publication
(10) Pub. No.: US 2021/0298374 A1
(43) Pub. Date: Sep. 30, 2021

(54) User-Configurable Mask with Filter Insert

(71) Applicant: Bryan E. Kilbey, DeFuniak Springs, FL (US)

(72) Inventor: Bryan E. Kilbey, DeFuniak Springs, FL (US)

(21) Appl. No.: 17/212,291

(22) Filed: Mar. 25, 2021

Related U.S. Application Data
(60) Provisional application No. 63/000,793, filed on Mar. 27, 2020.
(60) Provisional application No. 63/034,611, filed on Jun. 4, 2020.

(51) Int. Cl. A41D 13/11; A62B 23/02

(52) U.S. Cl. CPC A41D 13/113; A41D 13/1161; A62B 23/025

(57) ABSTRACT

A user-customizable mask. The mask includes a centralized body configured to cover the user's nose, mouth, and chin. A left ear strap and a right ear strap are provided. The ear straps each contain a distal loop configured to pass around an ear—thereby securing the mask to the user's face. The mask body has a hook-compatible surface. Each ear strap includes a hook panel configured to engage this hook-compatible surface and thereby secure each ear strap to the mask body. The position of each of the ear straps relative to the mask body can be varied infinitely by the user in order to provide a customized fit.

### CROSS-REFERENCES TO RELATED APPLICATIONS

This non-provisional patent application claims the benefit of two earlier-filed provisional patent applications by the same inventor. The non-provisional applications are: U.S. Ser. No. 63/000,793 filed on Mar. 27, 2020, and U.S. Ser. No. 63/034,611 filed on Jun. 4, 2020.

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

### 1. Field of the Invention

This invention relates to the field of medical products. More specifically, the invention comprises a microbe-destroying mask that can be easily reconfigured by a user to provide a customized and comfortable fit.

### 2. Description of the Related Art

Healthcare providers and other users commonly wear face masks to minimize the transmission of infectious pathogens. Most such masks work via filtration. The filtration media is small enough to stop an aerosol droplet and the pathogen the droplet contains. Unfortunately, these masks do not readily kill the pathogen. The mask itself may therefore become infected, particularly when an aerosol droplet clinging to the mask evaporates and leaves the pathogen behind.

Mask contamination is a long-recognized problem. The prior art solution is the provision of inexpensive disposable masks. The user regularly removes and discards the mask he or she is wearing. A new and fresh mask is then donned. This is a wasteful practice, in that a healthcare worker on a 12-hour shift commonly runs through twenty masks or more.

In addition, disposable masks must—of necessity—be made in the cheapest manner possible. Such masks are often made using press-formed paper filters with attached elastic ear loops. A deformable metal strip is often included in the area intended to fit over the nose. This deformable strip allows the user to pinch the mask around his or her nose, and thereby provide a rudimentary customized fit. Differences in facial size and geometry are accommodated by providing a range of mask sizes. These masks provide reasonable filtration, but gaps between the mask and the user's face allow some pathogens to bypass the filtration.

The prior art mask designs do allow a limited accommodation for varying users via the provision of the deformable strip and the provision of a range of sizes. They are not customizable, however, and many users can never achieve a good fit between the mask and the face. A loose fit reduces the mask's effectiveness, both in terms of limiting emissions from an infected wearer and limiting intake for a non-infected wearer.

The present invention provides a truly customizable mask that a user can configure to provide an excellent fit between the mask and the face. Further, the present invention provides an anti-microbial feature that is impractical for disposable masks.

### BRIEF SUMMARY OF THE PRESENT INVENTION

The present invention provides a user-customizable mask. The mask includes a centralized body configured to cover the user's nose, mouth, and chin. A left ear strap and a right ear strap are provided. The ear straps each contain a distal loop configured to pass around an ear—thereby securing the mask to the user's face.

The mask body has a hook-compatible surface. Each ear strap includes a hook panel configured to engage this hook-compatible surface and thereby secure each ear strap to the mask body. The position of each of the ear straps relative to the mask body can be varied infinitely by the user in order to provide a customized fit.

The mask body is preferably made of a 4-way elastic filtration material. This material, while hook-compatible, is preferably smooth and comfortable to wear against the skin. The mask body is preferably treated with a bonded antimicrobial. The entire mask assembly is preferably made washable so that it can be worn and reused many times—while retaining the bonded antimicrobial.

### BRIEF DESCRIPTION OF THE SEVERAL VIEWS OF THE DRAWINGS

FIG. 1 is a perspective view, showing a preferred embodiment of the present inventive mask.

FIG. 2 is a perspective view, showing the embodiment of FIG. 1 with the left ear strap partially detached.

FIG. 3 is an exploded perspective view, showing the embodiment of FIG. 1 in a partially disassembled state.

FIG. 4A is a plan view, showing a flat pattern of the two panels used to make the mask body in the embodiment of FIG. 1.

FIG. 4B is a perspective hidden line view, showing the two panels of FIG. 4A in an assembled state.

FIG. 4C is a perspective hidden line view, showing the two panels of FIG. 4A in an assembled state.

FIG. 5 is a plan view, showing the inward facing side and the outward facing side of a right ear strap.

FIG. 6 is an elevation view, showing the mask body and the ear straps in a disassembled state.

FIG. 7 is an elevation view, showing the two ear straps connected to the mask body and the use of lateral positioning of the ear straps to adjust the fit of the mask.

FIG. 8 is an elevation view, showing the tilting of the ear straps to adjust the fit of the mask.

FIG. 9 is an elevation view showing the tilting of the ear straps to adjust the fit of the mask and the trimming of material away from the mask body to provide a customized fit.

FIG. 10 is a perspective view, showing an exemplary trimming operation.

FIG. 11 is a perspective view, showing the attachment of a single antimicrobial molecular unit to a surface of the mask.

FIG. 12 is a perspective view, showing the interconnection of multiple molecular units.

FIG. 13 is a perspective view showing a first exemplary user.

FIG. 14 is a perspective view, showing the first exemplary user wearing the inventive mask.

FIG. 15 is a perspective view, showing a second exemplary user.

FIG. 16 is a perspective view, showing the second exemplary user wearing the inventive mask.

FIG. 17 is a plan view, showing an embodiment using a single piece of fabric for the mask body.

FIG. 18 is a plait showing a flat pattern for the mask body depicted in FIG. 17.

FIG. 19 is a perspective view, showing the embodiment of FIG. 18 after the superior and inferior relief cuts have been closed.

FIG. 20 is a plan view, showing a flat pattern for the removable filter.

FIG. 21 is a perspective view, showing the removable filter after it has been formed into its final state.

FIG. 22 is an exploded perspective view, showing the filter element in position for attachment to the unified mask body.

FIG. 23 is a perspective view, showing the components of FIG. 22 in an assembled state.

FIG. 24 is a sectional elevation view, showing the multiple layers used in the preferred embodiments.

FIG. 25 is a perspective view, showing a deformable nose piece.

FIG. 26 is a perspective view, showing the nose piece of FIG. 25 installed on a mask.

FIG. 27 is a plan view, showing the use of the nose piece.

FIG. 28 is a perspective view, showing the use of an integral strap instead of a nose piece.

### REFERENCE NUMERALS IN THE DRAWINGS

10 mask assembly

12 left panel

14 right panel

16 seam

18 left ear strap

20 right ear strap

22 left ear relief

24 right ear relief

26 inferior edge

27 left inferior edge

28 mask body

29 right inferior edge

30 superior edge

31 left superior edge

32 left lateral edge

33 right superior edge

36 hook panel

38 stitched seam

40 hook panel

42 distal loop

44 distal loop

46 right lateral edge

48 left medial edge

50 right medial edge

52 medial portion

54 removed portion

56 removed portion

58 cut

60 removed portion

62 substrate

64 covalent bond

66 cross-linking matrix

68 carbon chain

70 nitrogen atom

72 molecular unit

74 user

76 nose

78 chin

80 jaw

82 ear

83 outward facing surface

84 jowl

85 inward facing surface

87 outward facing surface

89 inward facing surface

90 axis of symmetry

92 unified mask body

94 flat pattern

96 superior relief cut

98 inferior relief cut

100 superior seam

102 inferior seam

104 central respiratory area

106 filter flat pattern

108 superior relief cut

110 inferior relief cut

112 hook panel

114 filter element

116 superior seam

118 inferior seam

120 laminated material

122 hook-compatible material

124 hook-compatible material

126 central material

128 nose piece

130 strap

132 hook panel

134 hook panel

136 integral strap

### DETAILED DESCRIPTION OF THE INVENTION

In this disclosure “directional terms” such as left, right, superior, inferior, medial, lateral, etc. are used. Such terms are referenced to the anatomy of a user actually wearing the inventive mask. So—as an example—a “left” ear strap is an ear strap configured to engage the user's left ear. If one provides a straight-on view of a user wearing the inventive mask, the “left” ear strap will appear on the right side of the view.

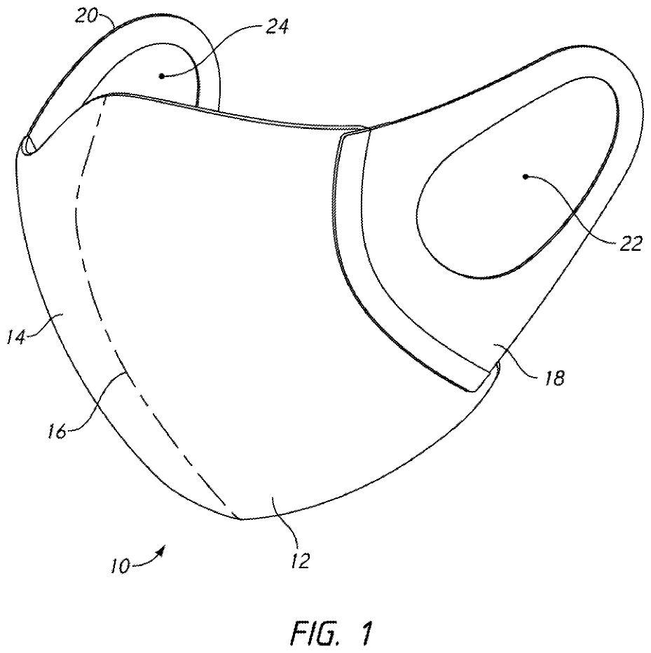

FIG. 1 shows an exemplary embodiment of the inventive mask assembly 10. In this example the mask assembly includes three main components. First there is a mask body made of elastic filtration material. The mask body is formed by the unification of left panel 12 with right panel 14 along seam 16. The second main component is left ear strap 18. This component includes left ear relief 22, which is configured to encompass the user's left ear. The third main component is right ear strap 20. This includes right ear relief 24, which is configured to encompass the user's right ear.

The mask body in this example is made as an assembly of two separate panels 12, 14. This approach allows the creation of a desired convex shape for the outward-facing surface of the mask. It is of course possible to make the mask body from a single piece of filtration material as well.

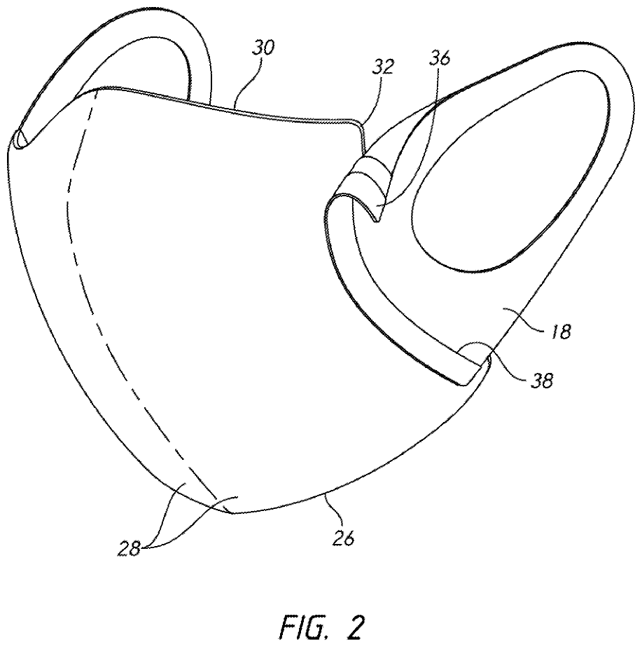

An important feature of the present invention is the fact that the user can vary the position and orientation of the ear straps 18, 20 with respect to the mask body. FIG. 2 illustrates a preferred approach to providing this functionality. The material used for mask body 28 is soft and pliable, It is comfortable to wear. At least the outward facing surface of the mask body is a hook-compatible surface. The term “hook-compatible surface” means a surface that can be engaged by a hook panel such as used in traditional hook-and-loop fasteners. A “hook-compatible” surface can be traditional coarse loop, However, in the example of FIG. 2, the hook-compatible surface is smooth and elastic. Its hook compatibility is not apparent to a user.

The upper medial corner of left ear strap 18 has been peeled back in FIG. 2. The user will observe that the inward facing surface of left ear strap 18 contains a hook panel 36. This hook panel extends along the medial portion of the left ear strap. The hook panel can be bonded to the ear strap material by any suitable method. In this version a stitched seam 38 is run through the left ear strap and the hook panel to create a secure attachment.

Left ear strap 18 is connected to mask body 28 via pressing hook panel 26 against the hook-compatible surface. The right ear strap likewise contains a hook panel on its inward facing surface so that it can be attached to the mask body by pressing it into place.

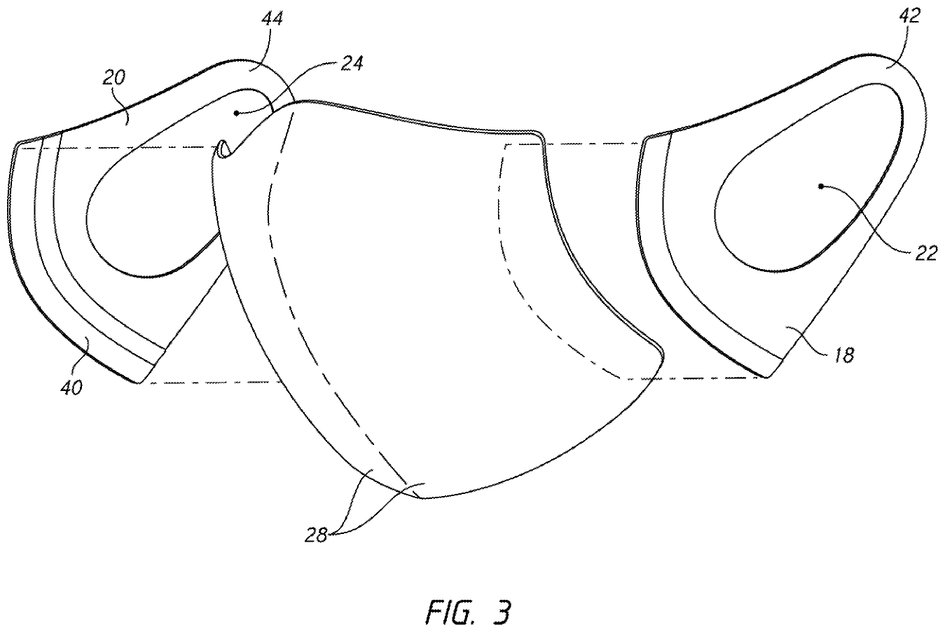

FIG. 3 shows the embodiment of FIG. 1 in an exploded state. Left ear strap 18 and right ear strap 20 have been pulled free of mask body 28. The reader will note that the inward facing surface of right ear strap 20 includes hook panel 40. Hook panel 40 is pressed against the outward-facing surface of mask body 28 in order to secure the right ear strap to the mask body.

The two ear straps are preferably made from soft elastic material that is comfortable against a user's skin. A distal loop 42,44 is provided in each ear strap. This distal loop passes around the ear. The larger outer ear structures (such as the helix and anti helix) pass through the ear reliefs 22, 24 as the ear straps are secured in place. The distal loops are configured to stretch in order to comfortably conform to a wide variety of ear geometry.

From these descriptions one skilled in the art will realize that a user can place each ear strap in any desired position and orientation with respect to mask body 28. This allows the user wide flexibility in customizing the fit of the mask, as will be explained subsequently.

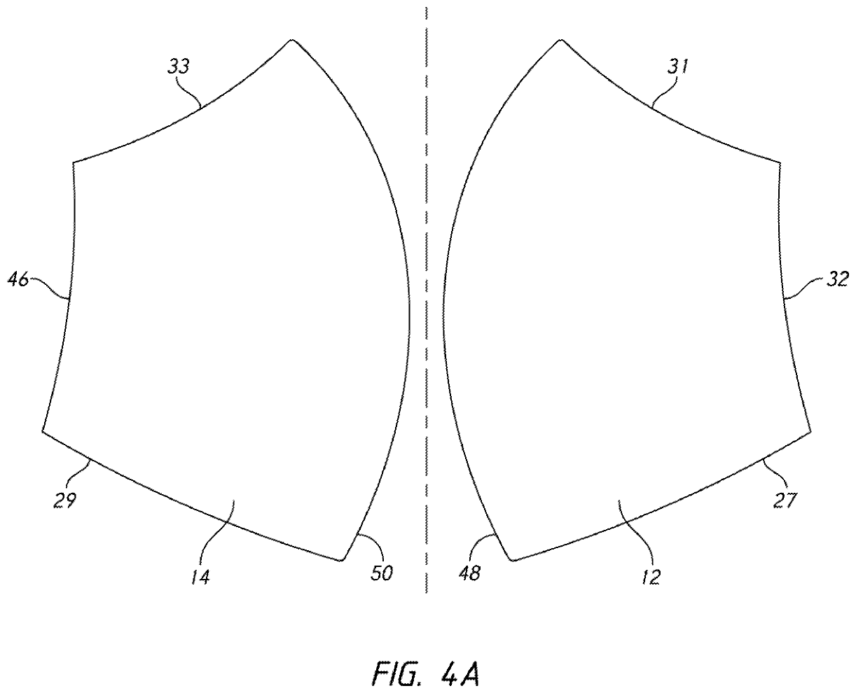

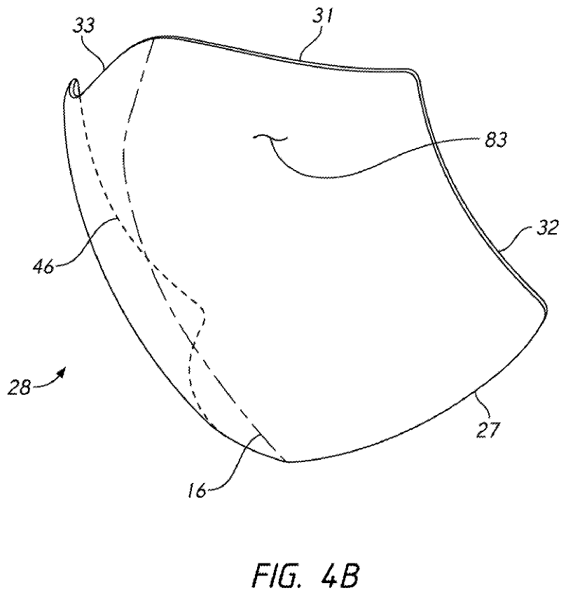

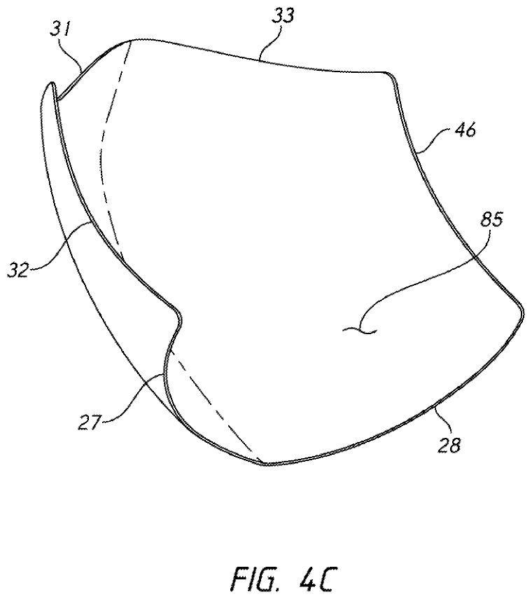

FIGS. 4A-4C describe one approach to creating a preferred convex shape for the mask body, FIG. 4A depicts a “flat pattern” for the mask body, where two panels are designed to be joined together. Left panel 12 and right panel 14 are mirror images of each other mirrored about the vertical dashed line depicted in the view (The reader should bear in mind the convention of “left” and “right” being assigned with respect to the anatomy of a user who is wearing the mask).

Left panel 12 is a flat piece of elastic filtration material that is bounded by left superior edge 31, left lateral edge 32, left inferior edge 27, and left medial edge 48. Right panel 14 is likewise a flat piece of elastic filtration material that is bounded by right superior edge 33, right lateral edge 46, right interior edge 29, and right medial edge 50.

In the manufacturing approach illustrated, left medial edge 48 is configured to be joined to right medial edge 50 in order to create seam 16 (such as depicted in FIG. 1). The two medial edges 48,50 include carefully created tangent curves. As those skilled in the art will know, when the curves depicted are joined. together, a convex outward facing surface will result for the mask body.

Looking briefly at FIG. 1, the reader will observe the convex outward-facing surface. booking at the path of seam 16, the reader will observe how the mask is curved to fit over the tip of the nose and curved to tuck under the chin. Returning now to FIG. 4A, it is possible to provide flat patterns of varying curvature along the medial edges 48,50—and thereby produce differing mask geometries. However, when a suitably elastic material is used for the panels 12,14 a single mask geometry can accommodate nearly every type of face geometry.

FIG. 4B shows the two mask panels after the two medial edges 48, 50 have been united along seam 16. The two panels can be sewn together using fine stitching that will not be noticeable to a user. The two panels can also be joined using adhesives or other suitable means. The reader will note how outward-facing surface 83 assumes a convex shape. The reader will also note how the curved shape of left superior edge 31 and right superior edge 33 combine to create a smooth superior edge for the mask body as a whole. The same is true for the inferior edges 27,29. The curved shape provided for left lateral edge 32 and right lateral edge 46 conforms more readily to the geometry- of the user's face. FIG. 4C shows the same assembly depicted in FIG. 4B from the opposite side. Inward facing surface 85 is concave, allowing it to better conform o the user's face.

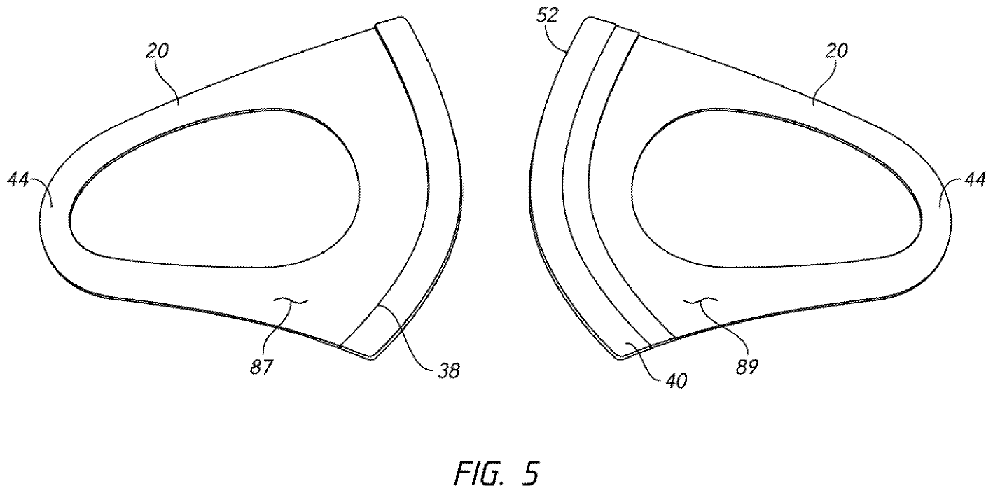

FIG. 5 depicts two samples of right ear strap 20, The sample on the right side of the view shows the inward-facing surface 89. The reader will note again the presence of hook panel 40 proximate its medial portion 52 (“medial” indicating the portion of the ear strap that is customarily placed closest to the middle of the mask body). The sample on the left side of the view shows outward facing side 87. Stitched seam is again used to secure the hook panel to the fabric of the ear strap.

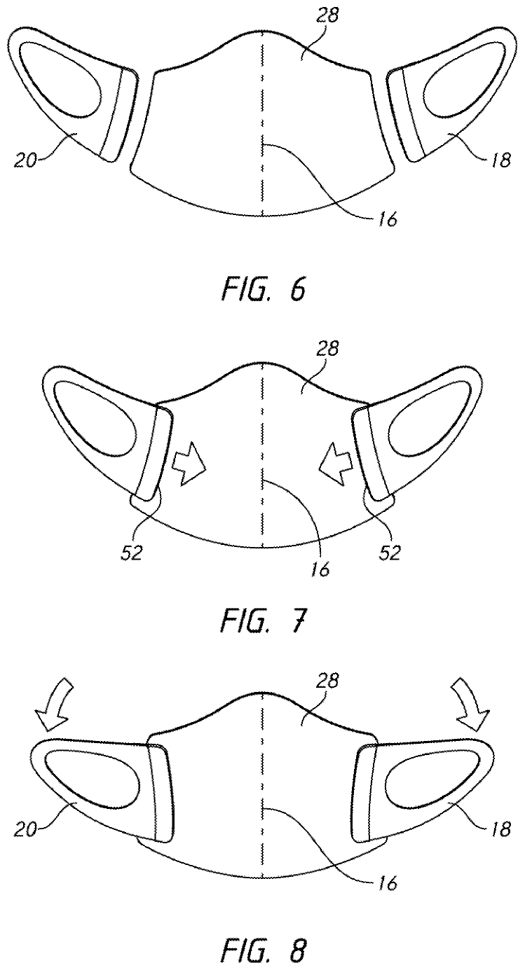

FIGS. 6-10 show some of the ways in which the inventive mask can be customized by a user. FIG. 6 provides a plan view looking at the outward facing surface of mask body 28. The two ear straps 18, 20 can be attached in any desired position. In some embodiments a dashed outline of a “default” position can be printed on the mask body.

FIG. 7 shows mask body 28 with the two ear straps attached. A primary adjustment is to move the medial portions 52 of the two ear straps toward the central seam 16 on the mask body. Moving the two medial portions toward the seam increases the tightness of the mask on the face, whereas moving the two medial portions away from the seam makes the mask less tight.

FIG. 8 depicts the rotational adjustment of the two ear straps compared to the mask body. In the example shown, the ear straps have been rotated so that the distal tips move downward (as shown by the arrows). This adjustment allows the user to account for differing vertical positions of the ears. Of course, many users will need a different ear elevation adjustment for the left and right ear straps. These differing adjustments are possible with the inventive mask.

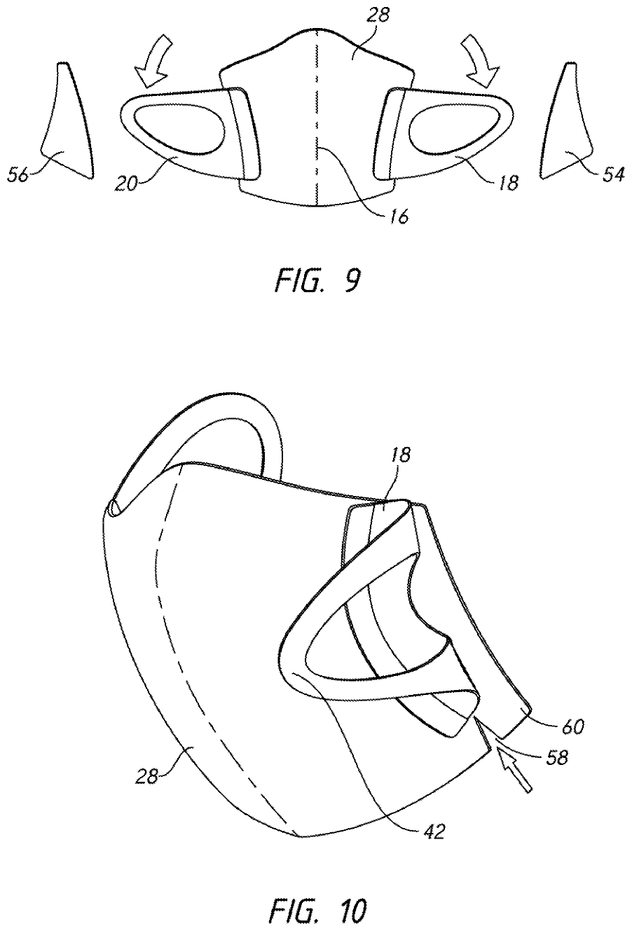

In the example of FIG. 9, the two ear straps 18,20 have been moved significantly inward. This action would typically be done by a user with a small or narrow face. When the ear straps have been moved inward to the extent shown in FIG. 9 the lateral edges of the mask body are often too close to the ears—which can be uncomfortable. The elastic filtration material preferably used for the mask can be cut as desired, without creating a frayed or otherwise unstable edge. Thus, once the ear straps are positioned, the user can take a cutting device and detach removed portion 54 from the left medial edge of the mask and detach removed portion 56 from the right medial edge of the mask.

FIG. 10 shows this operation in more detail. Once eft ear strap 18 is in the desired position, the user bends the ear strap over itself as shown (only the hook panel remains attached to the mask body). The user then employs a cutting device to make a cut 58 along the mask's medial edge. When the cut is complete, removed portion 60 is detached. The user can employ the same operation on the other side of the mask.

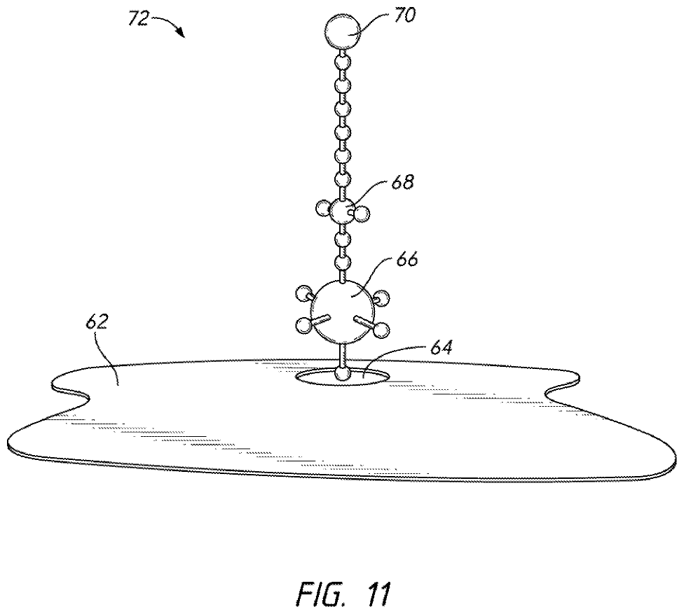

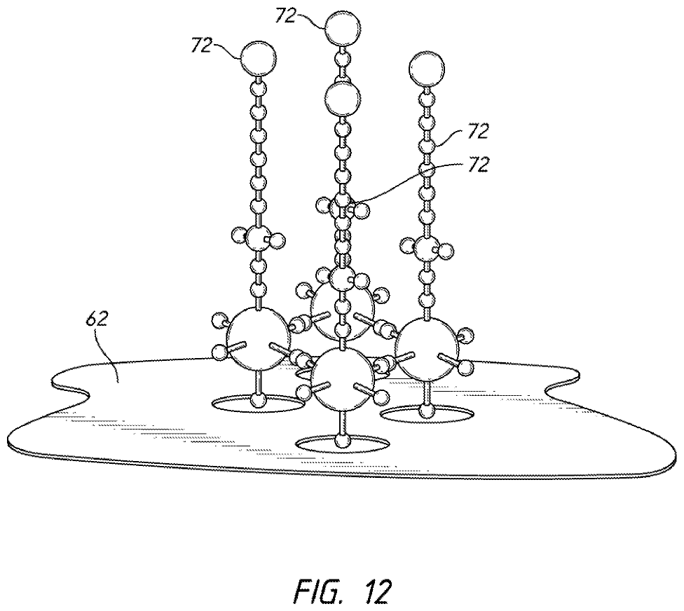

FIGS. 11 and 12 simplistically depict the preferred antimicrobial component of the inventive mask. FIG. 11 depicts a single molecular unit 72. The existence of a single molecular unit in this context is unrealistic and the depiction of FIG. 11 is therefore only provided for purposes of visual clarity. The molecular unit is bonded to substrate 62 of the filtration material via covalent bond 64. This covalent bond is able to survive the washing of the inventive mask—including he use of mild detergents.

Cross-linking matrix 66 is provided to link the individual molecular units to other molecular units. An ammonium group may be used for this purpose. A carbon chain 68 extends away from the substrate. A nitrogen atom 70 is bonded to the end of the carbon chain—providing a positive charge at this point.

FIG. 12 depicts a number of molecular units bonded to substrate 62 and cross-linked to each other. Four molecular units are shown but of course—in reality—many millions of cross-linked units will be present. Small particles approaching the substrate are attracted by the positively-charged nitrogen atoms 72. An approaching microorganism is drawn rapidly toward the interlinked molecular units where it is ultimately killed through a positive-negative ion exchange.

The microorganisms drawn into the web of molecular units are killed rapidly. In fact, the filtration material with the bonded antimicrobial units has been demonstrated to produce a 99.99% reduction in surface contamination. And—because the bonds remain despite repeated washing—the inventive mask can be reused many times.

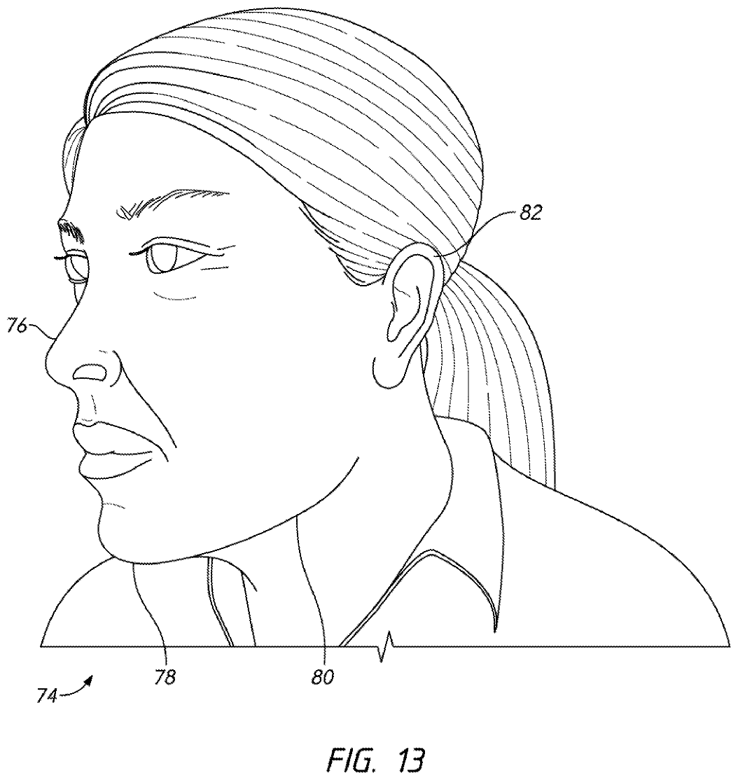

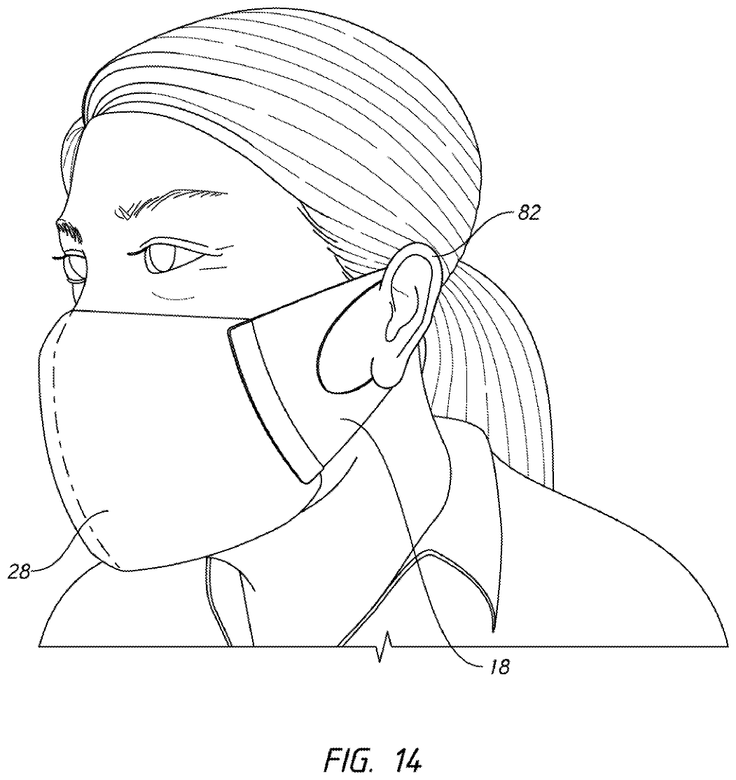

FIGS. 13-16 show two examples of how the mask can be configured for differing facial anatomy. FIG. 13 shows a female user 74 having a well-defined jaw 80 and chin 78. The face is narrow, but ears 82 are set back fairly far from nose 76. FIG. 14 shows the inventive mask being worn by the same female user. After experimenting to find the most comfortable position for the ear straps, she has reduced the overall height of the mask by trimming some of the inferior edge. She has also reduced the width somewhat by trimming the two lateral edges. The result is a snug fit over the tip of the nose, under the chin, and along the cheeks and jaws. No metal stays are required to produce this fit.

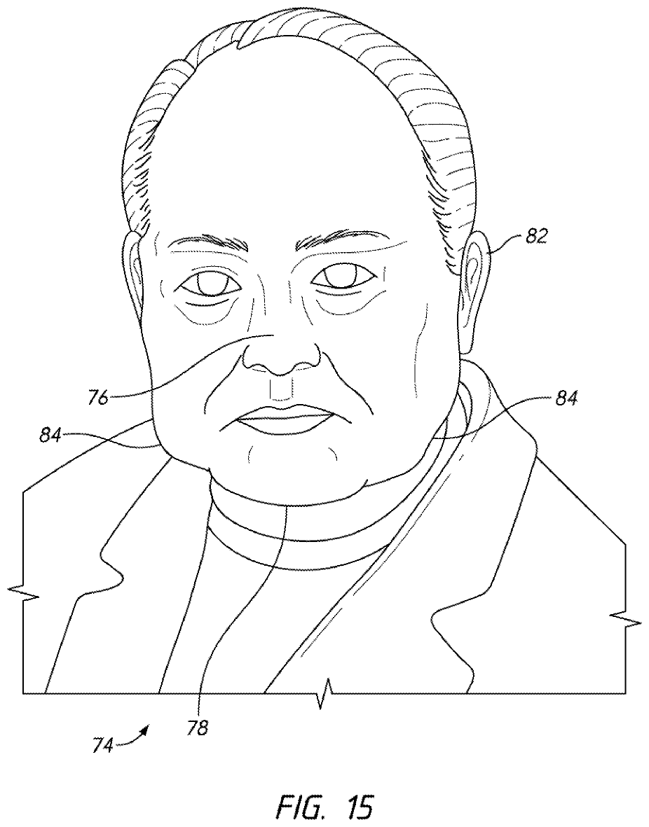

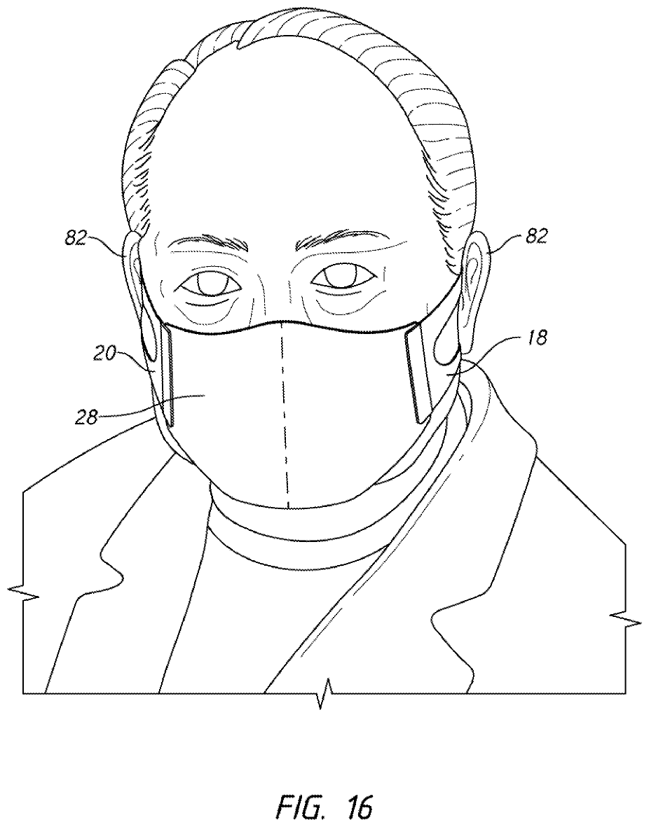

FIG. 15 shows another user with a completely different facial structure. This user has a less pronounced chin 78 and extended jowls 84. After positioning the ear straps in a very wide configuration, this user rotates the ear straps so that the inferior edge of the mask lies lower on the face. The result is shown in FIG. 16. The result is again a snug fit around the nose and chin, while also encompassing this particular user's broad jowls.

The two users thus illustrated represent widely diverging facial anatomy. The inventive mask is capable of fitting many more variations in facial anatomy.

The filtration material employed is of course significant to the operation of the invention. A four-way elastic material is preferably used. The term “four-way” means that the mask material can be stretched in any direction from a given point. A material with less elasticity can be used as well, but it is not preferred.

Suitably elastic filtration materials are often unable to filter particles smaller than about 5 microns. Viruses of interest are generally much smaller than this. However, those viruses are often contained in respiratory droplets that are much larger than 5 microns. The inventive mask preferably contains filtration material with a minimum exclusion size of about 5 microns, but with the additional antimicrobial molecular elements providing effective filtration down to a much smaller filter size. The mechanical filtration provided is comparable to common surgical masks. The addition of the antimicrobial elements provides even better performance.

The reusability of the mask is a significant feature. It is important in this regard to instruct the user as to the proper washing and handling of the mask. Warm water—but not hot water—should be used. A mild detergent can be used as well. Hand washing is preferable, as violent agitation can remove the antimicrobial elements. Air drying at ambient temperatures is also preferred.

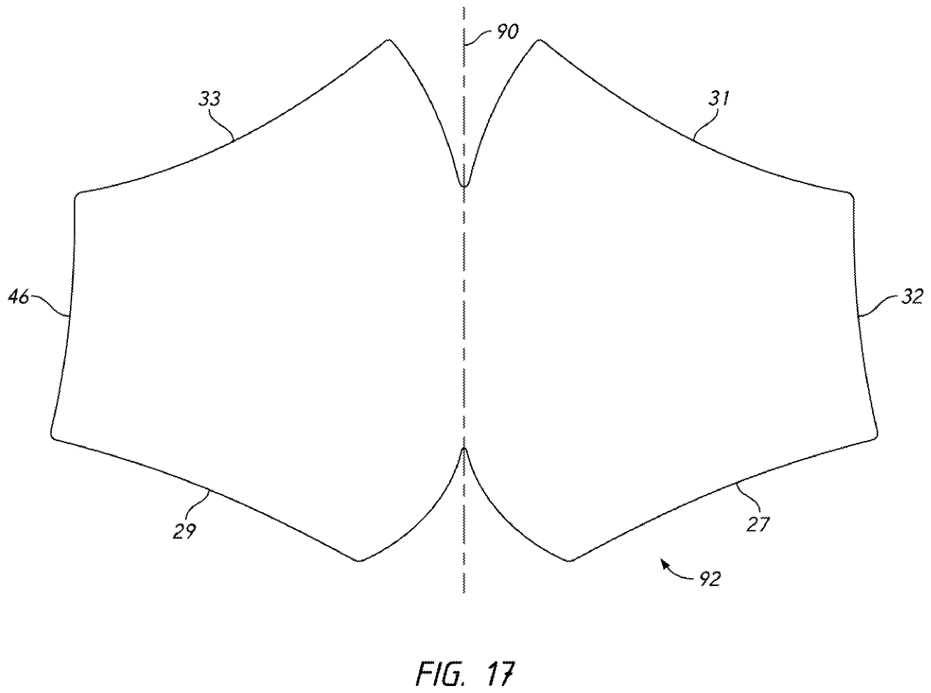

FIGS. 17-19 illustrate another preferred embodiment in which a single piece of material is used for the mask body—rather than an assembly of two separate pieces. In the embodiment of FIG. 17, unified mask body 92 includes perimeter features that are similar to those found in the embodiment of FIG. 4A. These include left superior edge 31, left lateral edge 32, left inferior edge 27, right inferior edge 29, tight lateral edge 46, and right superior edge 33. These features are mirrored about axis of symmetry 90.

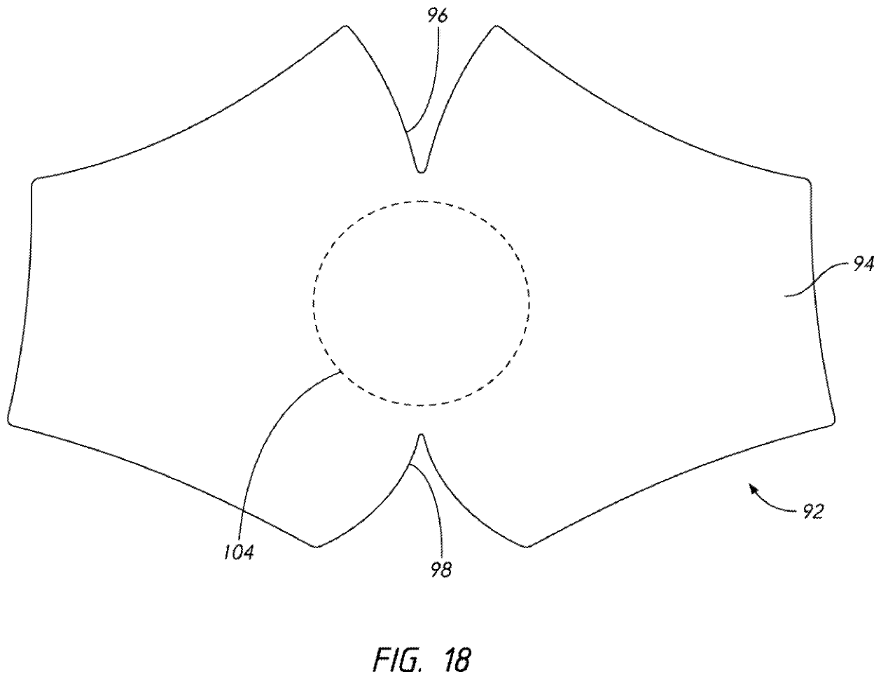

FIG. 18 shows the same embodiment without the axis of symmetry being depicted. Flat pattern 94 is preferably made from a single piece of fabric (though multiple layers may be present). It includes two relief cuts—superior relief cut 96 and inferior relief cut 98. Central respiratory area 104 lies between the two relief cuts. In use, central respiratory area 104 lies over the mouth and the tip of the nose. This configuration eliminates the presence of a seam in the area where most of the breathing air is transferred through the mask.

The relief cuts 96, 98 are shaped so that—when the two lateral sides of each relief cut are joined—a suitable contour for the mask is produced. The lateral sides can be joined by any suitable method. Stitching is one good example. In the context of this application, these edges are referred to as “joinable edges.” For example, superior relief cut 96 is bounded by a first paid of joinable edges that are intended to be joined together. Inferior relief cut 98 is bounded by a second pair of joinable edges (The reader should note that the two-piece fiat pattern of FIG. 48 also includes a pair of joinable edges 48, 50).

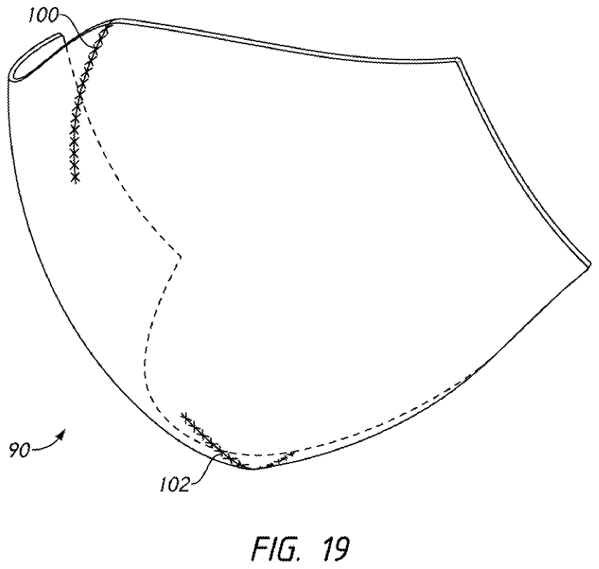

FIG. 19 provides a perspective view of unified mask body 92 after the joinable edges of the relief cuts 96, 98 have been joined by stitching. Superior seam 100 results from stitching the two joinable edges of superior relief cut 96 together. Likewise, inferior seam 102 results from stitching the two joinable edges of inferior relief cut 98 together.

In FIG. 19 the outward facing surface of unified mask body 92 faces the viewer. The reader will note how the joining of the two relief cuts forces the flat pattern into a convex shape that is suitable for covering a user's face. The shape is essentially the same as for the embodiment shown being worn by a user in FIG. 14. However, the embodiment of FIG. 19 has no seam in the central respiratory area where the majority of the air traveling through the mask passes. The presence of a well-sealed seam in this area actually does not reduce the effectiveness of the mask. However, the lack of a seam in this region is desirable to some users and the embodiment of FIG. 19 provides this feature.

In some applications the use of a filter insert is desirable. As an example, the “N95” mask specification is widely used in the medical field. “N95” refers to a standard promulgated by the National Institute for Occupational Safety (“NIOSH”). This mask specification is commonly referred to as “N95” or “NIOSH 95.” Surgical N95 respirators are cleared by both NIOSH and the Food and Drug Administration. The N95 mask material itself is capable of filtering particles down to about 0.3 microns (though poor mask-tip-face fit often limits the actual effectiveness of prior art N95 masks).

N95 masks typically use a fine mesh of synthetic polymer fibers, such as non-woven polypropylene. This material tends to be inelastic, which is one of the main reasons that masks using only such materials do not seal well against a user's face.

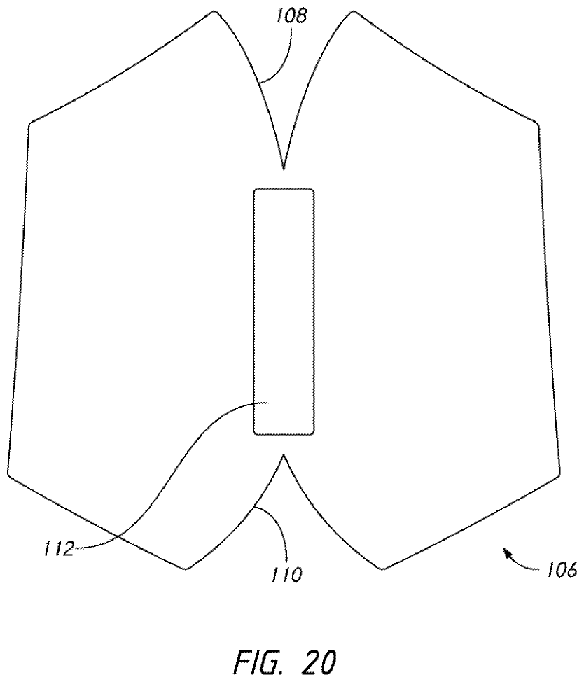

The embodiment of FIGS. 20-24 combines the elastic advantages of the present invention with the filtration performance of a traditional N95 mask. In order to do this, a removable filter element is added to the present inventive mask. FIG. 20 shows an embodiment of this removable element. Filter flat pattern 106 lies flat as shown. The material is preferably a suitable N95 filter material. Superior relief cut 108 is provided in the middle of its superior edge and inferior relief cut 110 is provided in the middle of its inferior edge. Each relief cut has two lateral edges. When these are joined, the fiat pattern is formed into a. convex shape so that it can fit closely within the mask body.

FIG. 20 shows the outward facing side of filter flat pattern 106. Hook panel 112 is adhered to this outward facing surface as shown. The hook panel can be attached using adhesive, stitching, or any other suitable method. As the hook panel is placed within the central respiratory area, it is desirable to minimize its surface area (the hook panel being obstructive to air flow. A narrow hook panel can be used—as shown. Alternatively, To separate hook panels with a gap in the middle can be used.

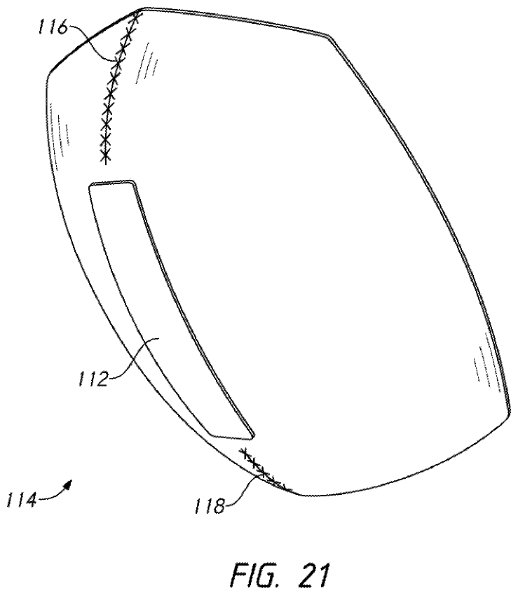

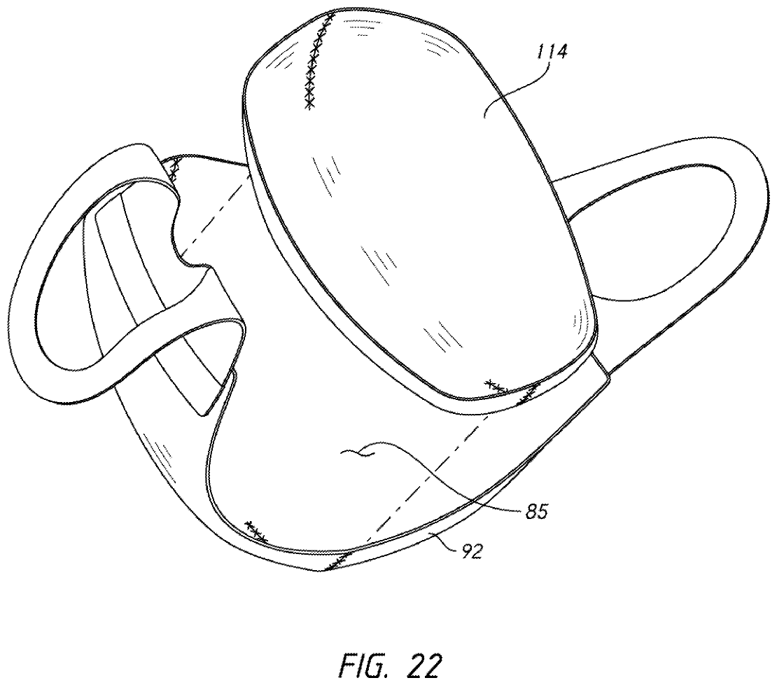

FIG. 21 shows filter element 114 after superior relief cut 108 has been stitched together to create superior seam 116 and inferior relief cut 110 has been stitched together to create inferior seam 118. The reader will note how the filter element has assumed a convex shape. The reader will also note that hook panel 112 lies on the protruding central portion of the filter element.

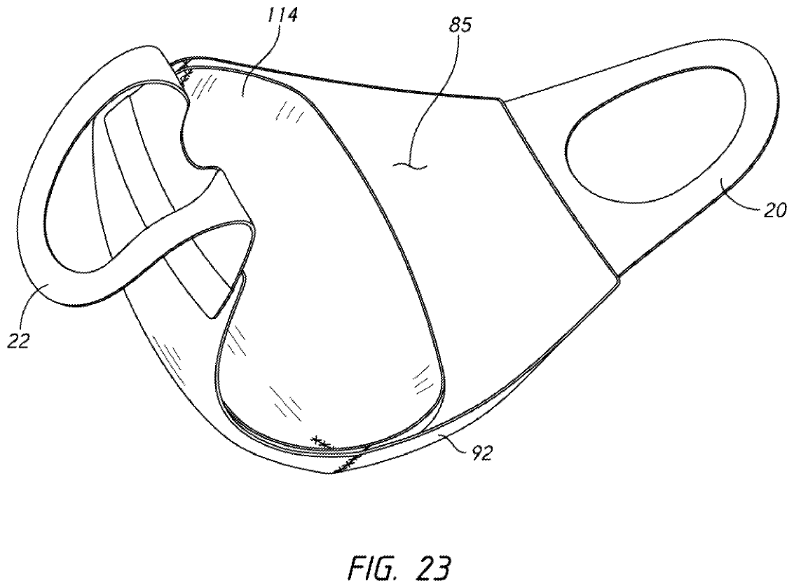

FIG. 22 depicts how filter element 114 is attached to the mask body—in this case unified mask body 92. Inward facing surface 85 of the unified mask body 92 is a hook-compatible material. The hook panel 112 on filter element 114 (facing away from the viewer in FIG. 22) is pressed against inward facing surface 85—thereby securing filter element 114 to unified mask body 92.

FIG. 23 shows the assembly with filter element 114 in place. The user dons the mask by pressing the central section against the nose and mouth and passing the ear straps 20, 22 around the ears. The elasticity of the unified mask body and ear straps allows a comfortable fit for many different users. Filter element 114 provides the advantages of a well-understood N95 filter material.

The mask body and ear straps can be used indefinitely. Periodic washing is advisable and—provided the washing is done without hot water or strong solvents—the efficacy of the mask body is unaffected. Filter element 114, however, is typically replaced at regular intervals. In order to replace the filter element, the user opens the mask as shown in FIG. 23, peels away the expended filter element, and sticks a fresh filter element n its place. This can be done in a matter of seconds.

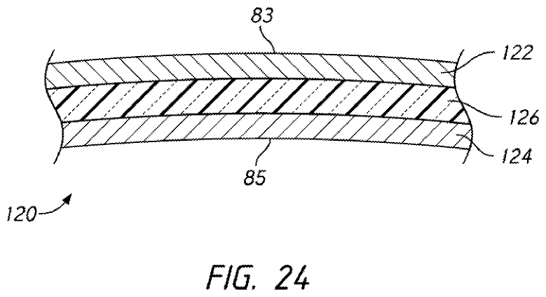

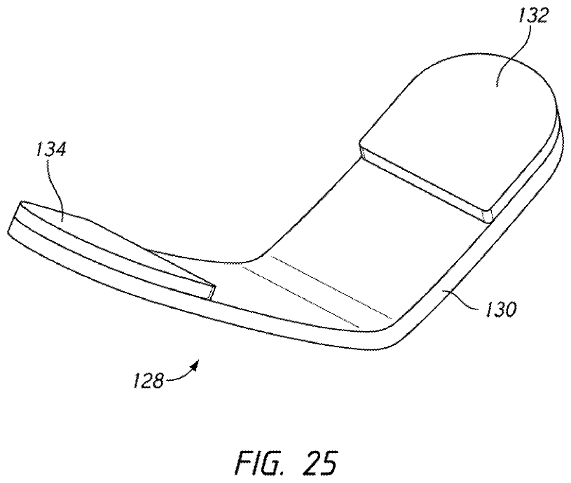

FIG. 24 provides a sectional view through an exemplary material that can be used for the unified mask body. Hook-compatible material 122 is used on the outward facing surface 83. Hook-compatible material 124 is used on the inward facing surface 85. Central material 126 preferably provides good elasticity and good filtration characteristics. All the materials are preferably coated with the anti-microbial agent described previously. The multiple layers may be joined into a cohesive unit via lamination or any other suitable method.

Returning now to FIG. 14, a problem experienced by some users will be explained. For some users, the middle portion of the nose urges the mask material away from the cheekbones. In this scenario exhaled air tends to escape the superior edges of the mask—rushing past either side of the nose. This air is then directed into the eyes, which may cause discomfort over time.

FIGS. 25-28 illustrate additional components configured to address this issue. FIG. 25 shows nose piece 128. Strip 130 includes a hook panel 132, 134 at each end. The strip is preferably made of an easily-deformable metal, such as unalloyed aluminum (“dead aluminum”). As those skilled in the art will know, it is easy to bend dead aluminum to a desired shape and it will then tend to retain that shape.

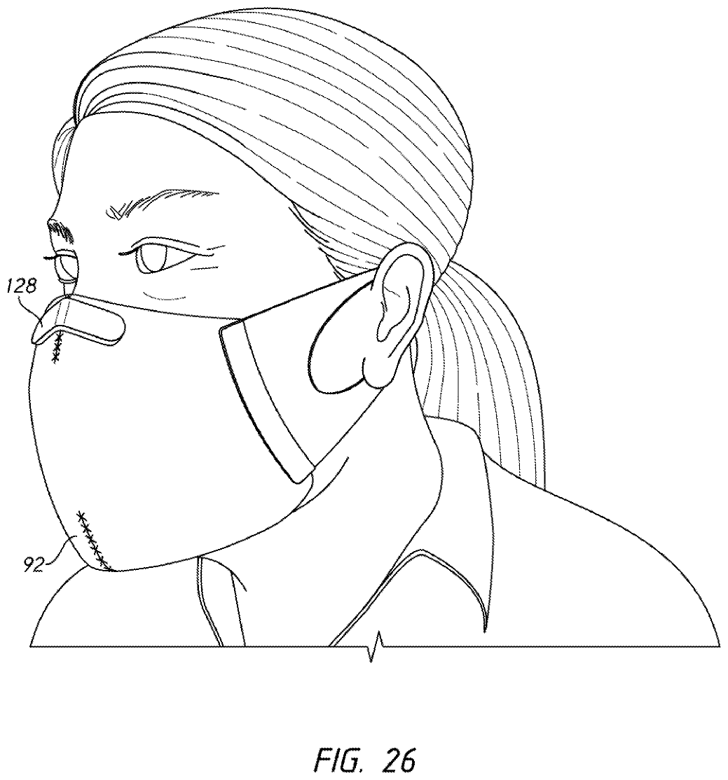

FIG. 26 shows the inventive mask with the addition of nose piece 128. Once unified mask body 92 is in place, the user presses nose piece 128 in position as shown. The user gently presses the dead aluminum strip around the nose. The hook panels 132, 134 on the inward facing side of the nose piece engage the hook-compatible material on the outward facing side of the mask body. The nose piece is thereby retained in position. The nose piece is strong enough to keep the superior edges of the mask body pressed against the user's cheek bones.

It is possible to furnish the nose pieces in various lengths. A relatively short length is shown in FIG. 26. However, a much longer length can be provided. A longer nose piece allows the user to conform the superior edge across a greater width. It is in fact possible to provide a nose piece that spans the entire superior edge of the mask body.

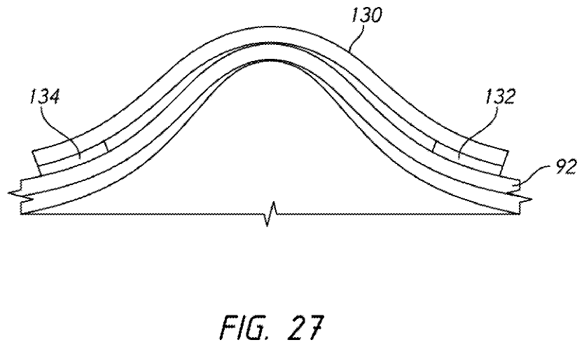

FIG. 27 shows a plan view of the nose piece in use. The region of unified mask body 92 shown is the region passing over the nose. The user bends metal strip 130 to conform to the shape of his or her nose. The metal strip is preferably soil, so that the bending can be done by pinching the strip between the thumb and the forefinger (with the thumb on a first side of the nose and the forefinger on the opposite side). Hook panels 132, 134 adhere to the hook-compatible outer surface on unified mask body 92 and retain the nose piece in position. Once the user has positioned and deformed the nose piece as desired, the nose piece will retain the shape.

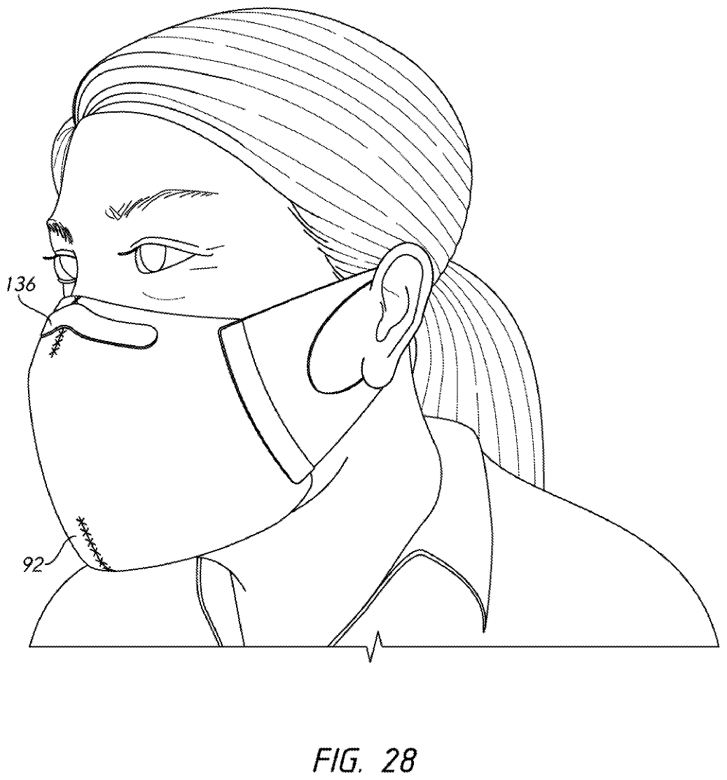

In some embodiments the nose piece will be made as an integral part of the mask body itself. FIG. 28 shows this embodiment. In this example a strip of dead aluminum is contained within a pocket that is bonded to the fabric of the mask body (integral strip 136). It is not removable, but it may still be deformed as desired to fit the user. It can also be deformed multiple times in case the first effort is unsatisfactory.

Many more features and variation are possible for the inventive mask. These include, without limitation:

1. The separate insert comprising the additional filtration material can be included in a pocket in the mask body;

2. The mask body can include multiple soft metal strips that the user can bend to alter the shape of the mask to better fit the face;

3. The ear straps can be made of a single layer of die-cut elastic material;

4. The ear straps can be an assembly of inflexible material joined to a loop of elastic material;

5. The mask body can be made of a single piece of material that is deformed into the desired convex shape;

6. The mask body can be provided with a hook-compatible surface only on its inward-facing side, so that the filter element and the ear straps can be attached to the inward-facing side; and

7. The hook-compatible surface does not necessarily cover the entire inward or outward facing side of a mask body. The hook-compatible surface may comprise less than the total surface.

The features thus described for various embodiments can be combined in different ways. Additional embodiments are thus possible via mixing and matching the features described. Although the preceding descriptions present considerable detail they should be properly viewed as illustrating embodiments of the present invention rather than limiting the scope of the invention. Many more embodiments following the same principles will occur to those skilled in the art. Accordingly, the scope of the invention should be fixed by the following claims rather ban by the examples given.

Having described my invention, I claim:

1. A method for customizing a fit of a mask for a user having a nose, a mouth, a right ear, and a left ear, comprising:
(a) providing a mask body made of elastic filtration material, including,
(i) a hook-compatible outward facing surface,
(ii) a left lateral edge,
(iv) a right lateral edge;
(b) providing a left ear strap, including,
(i) a left medial portion,
(ii) a left distal loop,
(iii) a left ear strap inward facing side,
(iv) a left hook panel on said inward facing side of said medial portion of said left ear strap;
(c) providing a right ear strap, including,
(i) a right medial portion,
(ii) a right distal loop,
(iii) a right ear strap inward facing side,
(iv) a right hook panel on said inward facing side of said medial portion of said right ear strap;
(d) adjusting a position of said left ear strap with respect to said mask body so that said left distal loop fits comfortably over said left ear;
(e) attaching said left ear strap to said mask body by pressing said left hook panel on said left ear strap against said hook-compatible outward facing surface on said mask body;
(f) adjusting a position of said right ear strap with respect to said mask body so that said right distal loop fits comfortably over said right ear; and
(g) attaching said right ear strap to said mask body by pressing said right hook panel on said right ear strap against said hook-compatible outward facing surface on said mask body.

2. The method for customizing a fit of a mask for a user as recited in claim 1, wherein said mask body has a convex shape.

3. The method for customizing a fit of a mask for a user as recited in claim 2, wherein said convex shape is formed by joining together edges of a flat pattern.

4. The method for customizing a fit of a mask for a user as recited in claim 1, further comprising:
(a) providing a hook-compatible inward facing surface on said mask body;
(b) providing a filter element including an outward-facing hook panel; and
(c) attaching said filter element to said mask body by pressing said outward-facing hook panel on said filter element against said inward facing surface on said mask body.

5. The method for customizing a fit of a mask for a user as recited in claim 4, wherein said filter element is given a convex shape.

6. The method for customizing a fit of a mask for a user as recited in claim 1, wherein said mask body comprises three layers, with an outer layer being a hook-compatible material, a central layer being made of a material having good elasticity and filtration characteristics, and an inner layer being a hook-compatible material.

7. The method for customizing a fit of a mask for a user as recited in claim 1, further comprising:
(a) providing a nose piece including a deformable strip having a first hook panel on a first end and a second hook panel on a second end;
(b) attaching said nose piece to said mask body by pressing said first ad second hook panels on said nose piece against said hook-compatible outward facing surface of said mask body; and
(c) deforming said deformable strip to adjust a fit of said mask body around said nose.

8. A method for customizing a fit of a mask for a user having a nose, a mouth, a right ear, and a left ear, comprising:
(a) providing a mask body made of elastic filtration material, including a hook-compatible surface;
(b) providing a left ear strap, including,
(i) a left medial portion,
(ii) a left distal loop,
(iii) a left ear strap inward facing side,
(iv) a left hook panel on said inward facing side of said medial portion of said left ear strap;
(c) providing a right ear strap, including,
(i) a right medial portion,
(ii) a right distal loop,
(iii) a right ear strap inward facing side,
(iv) a right hook panel on said inward facing side of said medial portion of said right ear strap;
(d) adjusting a position of said left ear strap with respect to said mask body so that said left distal loop fits comfortably over said left ear;
(e) attaching said left ear strap to said mask body by pressing said left hook panel on said left ear strap against said hook-compatible surface on said mask body;
(f) adjusting a position of said right ear strap with respect to said mask body so that said right distal loop fits comfortably over said right ear; and
(g) attaching said right ear strap to said mask body by pressing said right hook panel on said right ear strap against said hook-compatible surface on said mask body.

9. The method for customizing a fit of a mask for a user as recited in claim 8, wherein said mask body has a convex shape.

10. The method for customizing a fit of a mask for a user as recited in claim 8, wherein said mask body is made of trimmable material so that excess material can be trimmed away without leaving a frayed edge.

11. The method for customizing a fit of a mask for a user as recited in claim 8, further comprising:
(a) providing a hook-compatible inward facing surface on said mask body;
(b) providing a filter element including an outward-facing hook panel; and
(c) attaching said filter element to said mask body by pressing said outward-facing hook panel on said filter element against said inward facing surface on said mask body.

12. The method for customizing a fit of a mask for a user as recited in claim 11, wherein said filter element is given a convex shape.

13. The method for customizing a fit of a mask for a user as recited in claim 8, wherein said mask body comprises three layers, with an outer layer being a hook-compatible material, a central layer being made of a material having good elasticity and filtration characteristics, and an inner layer being a hook-compatible material.

14. The method for customizing a fit of a mask for a user as recited in claim 8, further comprising:
(a) providing a nose piece including a deformable strip having a first hook panel on a first end and a second hook panel on a second end;
(b) attaching said nose piece to said mask body by pressing said first ad second hook panels on said nose piece against said hook-compatible outward facing surface of said mask body; and
(c) deforming said deformable strip to adjust a fit of said mask body around said nose.

15. A method for customizing a fit of a mask for a user having a nose, a mouth, a right ear, and a left ear, comprising:
(a) providing a mask body made of elastic filtration material, including a hook-compatible outward facing surface;
(b) providing a left ear strap, including a left distal loop and a left hook panel on an inward facing side of said left ear strap;
(c) providing a right ear strap, including a right distal loop and a right hook panel on an inward facing side of said right ear strap;
(d) adjusting a position of said left ear strap with respect to said mask body so that said left distal loop fits comfortably over said left ear;
(e) attaching said left ear strap to said mask body by pressing said left hook panel on said left ear strap against said hook-compatible outward facing surface on said mask body;
(f) adjusting a position of said right ear strap with respect to said mask body so that said right distal loop fits comfortably over said right ear; and
(g) attaching said right ear strap to said mask body by pressing said right hook panel on said right ear strap against said hook-compatible outward facing surface on said mask body.

16. The method for customizing a fit of a mask for a user as recited in claim 15, wherein said mask body has a convex shape.

17. The method for customizing a fit of a mask for a user as recited in claim 15, wherein said mask body is made of trimmable material so that excess material can be trimmed away without leaving a frayed edge.

18. The method for customizing a fit of a mask for a user as recited in claim 15, further comprising:
(a) providing a hook-compatible inward facing surface on said mask body;
(b) providing a filter element including an outward-facing hook panel; and
(c) attaching said filter element to said mask body by pressing said outward-facing hook panel on said filter element against said inward facing surface on said mask body.

19. The method for customizing a fit of a mask for a user as recited in claim 18, wherein said filter element is given a convex shape.

20. The method for customizing a fit of a mask for a user as recited in claim 15, wherein said mask body comprises three layers, with an outer layer being a hook-compatible material, a central layer being made of a material having good elasticity and filtration characteristics, and an inner layer being a hook-compatible material.
